(19) United States
(12) Patent Application Publication
(10) Pub. No.: US 2018/0254653 A1
(43) Pub. Date: Sep. 6, 2018

(54) CHARGE CONTROL DEVICE

(71) Applicant: HITACHI AUTOMOTIVE SYSTEMS, LTD., Ibaraki (JP)

(72) Inventors: Takayuki TANAKA, Hitachi-shi (JP); Hiroyuki SHOJI, Hitachinaka-shi (JP)

(73) Assignee: HITACHI AUTOMOTIVE SYSTEMS, LTD., Ibaraki (JP)

(21) Appl. No.: 15/760,466

(22) PCT Filed: Aug. 2, 2016
(86) PCT No.: PCT/JP2016/072573

§ 371 Date: Mar. 15, 2018

(30) Foreign Application Priority Data
Sep. 29, 2015 (JP) 2015-190612

(51) Int. Cl. H02J 7/02; H02J 7/00; B60L 11/18

(52) U.S. Cl. CPC H02J 7/022; H02J 7/0013; B60L 2210/10; B60L 11/1868; B60L 2210/30; B60L 11/1811

(57) ABSTRACT

Even when power source is not input from outside, a device is activated. In step S4, after receiving information indicating start of charging from an upper control unit, a charge control unit transmits a signal to turn ON a switch to a switch control circuit. Accordingly, the switch is turned ON, and an AC power source from a vehicle exterior part is input to a charging circuit. In step S5, the charge control unit turns ON a switch SW2 based on vehicle state information and charging state information obtained via communication CAN with the upper control unit of the vehicle and supplies power of the AC power source as a power input source of a power source circuit. In step S9, the charge control unit turns ON a switch SW3 and supplies power of a high voltage battery as the power input source of the power source circuit.

### TECHNICAL FIELD

The present invention relates to a charge control device.

### BACKGROUND ART

Generally, an electric vehicle such as a hybrid vehicle and an electric car includes a low voltage battery and a high voltage battery. Then, an on-vehicle power source circuit receives power source from the low voltage battery to supply power source to drive electric components such as a microcomputer and a relay. However, the voltage of the low voltage battery largely fluctuates, and even in a case where the voltage of the low voltage battery is largely drops, the power source circuit needs to operate. However, in this case, the voltage drop causes an increase in an input current and an increase in sizes and costs of a transformer and a circuit element. Therefore, there has been a charging system for inputting an external AC power source instead of the low voltage battery and generating power source to be supplied to the microcomputer (refer to PTL 1).

### CITATION LIST

### Patent Literature

PTL 1: JP 2012-55043 A

### SUMMARY OF INVENTION

### Technical Problem

However, in the related art, in a state where the power source is not input from outside, power source to the microcomputer is unavailable. Therefore, the charging system cannot be activated.

### Solution to Problem

A charge control device according to the present invention includes a converter circuit which converts power supplied from an external power source and charges a low voltage battery and a high voltage battery, a converter control circuit which controls the converter circuit, and a power source circuit which receives supply of power from the power source or the high voltage battery and supplies power to the converter control circuit.

### Advantageous Effects of Invention

According to the present invention, it is possible to activate a device even in a state where power source is not input from outside.

### BRIEF DESCRIPTION OF DRAWINGS

FIG. 1 is an overall system diagram of a charging system.

FIG. 2 is a flowchart illustrating an operation of the charging system.

### DESCRIPTION OF EMBODIMENTS

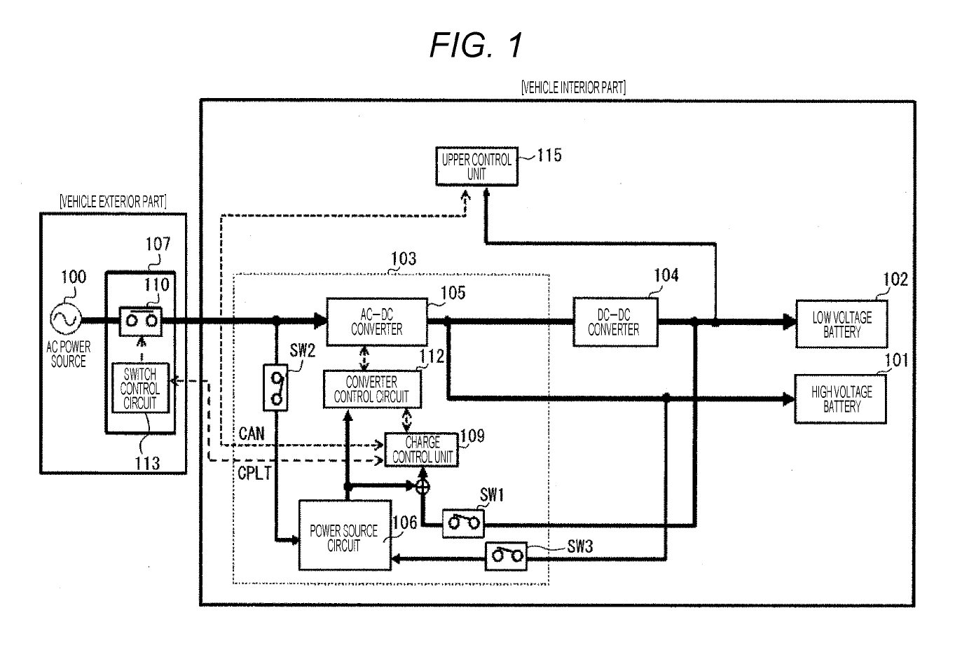

Hereinafter, an embodiment of the present invention is described with reference to the drawings as an example in which the present invention is applied to an electric vehicle such as a hybrid vehicle or an electric car. FIG. 1 is a diagram of an overall system of a charging system according to the present embodiment.

As illustrated in FIG. 1, the charging system is roughly divided into a vehicle exterior part and a vehicle interior part. The vehicle exterior part includes an AC power source 100 and a power source supply circuit 107.

The structure of the vehicle exterior part is described. The AC power source 100 is a domestic AC power source. In the present embodiment, the domestic AC power source is used. However, one of a plurality of DC power sources in the vehicle may be used.

The power source supply circuit 107 includes a switch 110 that relays the AC power source 100 to a charging circuit 103 to be described later and a switch control circuit 113 that controls switching of the switch 110. The switch control circuit 113 communicates with a charge control unit 109 to be described later by a communication CPLT, and receives a command from the charge control unit 109 to control opening/closing of the switch 110.

The structure of the vehicle interior part is described. The vehicle interior part includes an upper control unit 115 for integrally controlling the entire vehicle, the charging circuit 103, a high voltage battery 101, a low voltage battery 102, and a DC-DC converter 104. The upper control unit 115 performs higher-level control in the vehicle interior part, and is, for example, a control microcomputer.

Although the charging circuit 103 is described in detail later, the charging circuit 103 converts the power source from the AC power source 100 from the vehicle exterior part as an input source into a DC power and supplies the DC power to the DC-DC converter 104 and the high voltage battery 101. A high voltage output from the charging circuit 103 is stepped down by the DC-DC converter 104 and is supplied to the low voltage battery 102.

Two types of batteries, i.e., the high voltage battery 101 and the low voltage battery 102 are usually provided in the electric vehicle. The high voltage battery 101 is mainly used as a power source for a high voltage load such as a drive motor of the electric vehicle. The low voltage battery 102 is mainly used as a power source for various low voltage loads in the vehicle such as a car audio device and a wiper.

The charging circuit 103 is described. The charging circuit 103 includes an AC-DC converter 105, a converter control circuit 112, the charge control unit 109, a power source circuit 106, and switches SW1, SW2, and SW3. The AC-DC converter 105 converts the AC power received from the AC power source 100 in the vehicle exterior part into the DC power and supplies the DC power to the high voltage battery 101 and the DC-DC converter 104.

The converter control circuit 112 controls power, to charge the high voltage battery 101, relative to the AC-DC converter 105. The charge control unit 109 is configured by a microcomputer and executes processing illustrated in a flowchart to be described later. First, the charge control unit 109 communicates with the upper control unit 115 via the communication CAN and notifies a connection state of a charging cable, the maximum current which can be supplied, and an availability of power source. Furthermore, communication with the switch control circuit 113 by the communication CPLT is performed, a request for starting/stopping charging is notified. In addition, the charge control unit 109 outputs a drive control signal to the converter control circuit 112 for driving the AC-DC converter 105.

The power source circuit 106 includes, for example, a transformer, a rectifier circuit, a smoothing capacitor, and the like which are not shown, and the AC power source 100 from vehicle exterior part is input via the switch SW2. Then, the power source circuit 106 generates various power sources such as a power source for driving the charge control unit 109 and a power source for driving the converter control circuit 112 and supplies the power sources.

The switch SW1 is turned ON in response to a command from the upper control unit 115 when the electric vehicle is activated. As the switch SW1 is turned ON, the charge control unit 109 receives power source from the low voltage battery 102, and the charge control unit 109 is activated. As a result, the charge control unit 109 becomes operable, and recognizes the communication CPLT transmitted from the switch control circuit 113 of the power source supply circuit 107. Furthermore, if it is found that charging is available by communicating with the upper control unit 115 of the vehicle via the communication CAN, a notification is issued to the switch control circuit 113 by the communication CPLT. Then, the switch 110 is turned ON, and power of the AC power source 100 from the vehicle exterior part is supplied to the charging circuit 103.

In a case where the power of the AC power source 100 can be supplied from the vehicle exterior part to the charging circuit 103 by turning ON the switch 110 by the control of the switch control circuit 113 described above, the charge control unit 109 turns ON the switch SW2. Then, the power of the AC power source 100 is supplied from the vehicle exterior part as a power input source of the power source circuit 106.

Furthermore, in a case where the vehicle is traveling and the charging is available, the charge control unit 109 turns ON the switch SW3. Accordingly, power from the high voltage battery 101 is supplied as the power input source of the power source circuit 106.

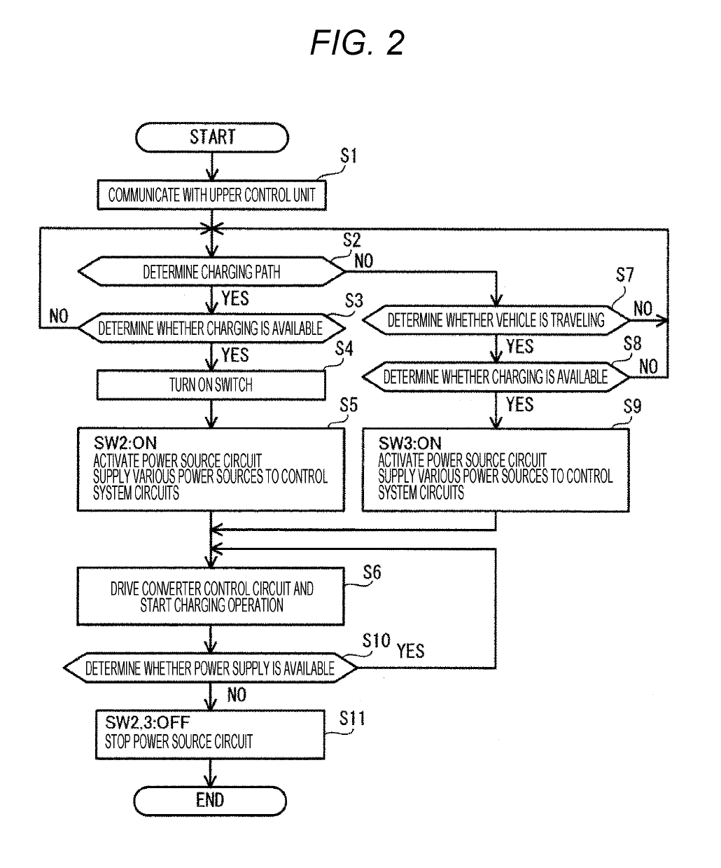

An operation of the charging system according to the present embodiment is described with reference to FIG. 2. FIG. is a flowchart illustrating the operation of the charge control unit 109. When the electric vehicle is activated, the switch SW1 is turned on according to a command from the upper control unit 115. The switches SW2 and SW3 are in an OFF state. As the switch SW1 is turned ON, the charge control unit 109 receives power source from the low voltage battery 102, and the charge control unit 109 is activated.

When the charge control unit 109 is activated, in step S1, the charge control unit 109, which has received power source from the low voltage battery 102, performs the communication CPLT with the switch control circuit 113 and communicates with the upper control unit 115 of the vehicle via the communication CAN to perform processing for acquiring states such as the connection state of the charging cable, the maximum current which can be supplied, a notification indicating availability of power source.

In step S2, the charge control unit 109 detects whether a power supply plug is connected between the power source supply circuit 107 and the charging circuit 103. In this detection, the connection state of the charging cables is determined based on state acquisition information obtained by the communication CPLT between the power source supply circuit 107 and the charging circuit 103. If the power supply plug is connected, the procedure proceeds to step S3, and if the power supply plug is not connected, the procedure proceeds to step S7.

In step S3, it is determined whether charging is available. Specifically, it is determined whether charging is available based on the information received from the power source supply circuit 107 by the charge control unit 109 with communication CPLT and information on a vehicle state obtained via the communication CAN with the upper control unit 115. If charging is not available, the procedure returns to step S2, and if charging is available, the procedure proceeds to step S4.

In step S4, after receiving the information indicating the start of charging from the upper control unit 115 via the communication CAN, the charge control unit 109 transmits a signal to turn ON the switch 110 by the communication CPLT to the switch control circuit 113. As a result, the switch 110 is turned ON, and the AC power source 100 is input from the vehicle exterior part to the charging circuit 103.

In step S5, the charge control unit 109 turns ON switch SW2 based on vehicle state information and charging state information obtained via the communication CAN with the upper control unit 115 of the vehicle and supplies the power of the AC power source 100 from the vehicle exterior part as the power input source of the power source circuit 106. The power source circuit 106 which has received the power source from the AC power source 100 generates various power sources and supplies power to the converter control circuit 112 and the charge control unit 109. At this time, the switches SW1 and SW3 are in the OFF state.

In step S6, the converter control circuit 112 is driven and the AC-DC converter 105 and DC-DC converter 104 are controlled so that a charging operation is started. In step S7, it is determined whether the vehicle is traveling based on the state acquisition information obtained by the communication CPLT with the power source supply circuit 107 and the vehicle state information obtained via the communication CAN with the upper control unit 115 of the vehicle. If the vehicle is not traveling, the procedure returns to step S2, and if the vehicle is traveling, the procedure proceeds to step S8.

In step S8, similarly to step S3 described above, it is determined whether charging is available. If charging is not available, the procedure returns to step S2, and if charging is available, the procedure proceeds to step S9. In step S9, the charge control unit 109 turns ON the switch SW3 and supplies power of the high voltage battery 101 as the power input source of the power source circuit 106. At this time, the switches SW1 and SW2 are in the OFF state.

In step S10, the charge control unit 109 communicates with the upper control unit 115 of the vehicle via the communication CAN, obtains the vehicle state information and the charging state information from the upper control unit 115, and determines whether power supply processing for supplying power to the power source circuit 106 via the SW2/SW3 can be performed. If the power supply is available, the procedure returns to step S6, and if the power supply is not available, the procedure proceeds to step S11. In step S11, the switches SW2 and SW3 are turned OFF, and the power supply is stopped.

According to the embodiment described above, the following operational effects can be obtained.

(1) The charging circuit 103 includes the AC-DC converter 105 which converts power supplied from the external AC power source 100 and charges the low voltage battery 102 and the high voltage battery 101, the converter control circuit 112 which controls the AC-DC converter 105, and the power source circuit 106 which receives power source from the AC power source 100 or the high voltage battery 101 and supplies power to the converter control circuit 112. Accordingly, the charging circuit 103 can be activated even in a state where the AC power source 100 is not input.

### Modification

The present invention can be implemented by modifying the above-described embodiment as follows.

(1) An example has been described in which the AC power source 100 is supplied from the vehicle exterior part. However, a DC power may be supplied. In this case, the AC-DC converter 105 uses a DC-DC converter, and the components in the power source circuit 106 such as a transformer, a rectifier circuit, and a smoothing capacitor are unnecessary.

The present invention is not limited to the embodiment, and other forms which are considered within the technical idea of the present invention are also included within the scope of the present invention as long as the features of the present invention are not impaired. Furthermore, a combination of the above embodiment and the modification may be used.

### REFERENCE SIGNS LIST

100 AC power source
101 high voltage battery
102 low voltage battery
103 charging circuit
104 DC-DC converter
105 AC-DC converter
106 power source circuit
109 charge control unit
110 switch
112 converter control circuit
113 switch control circuit
115 upper control unit

1. A charge control device comprising:
a converter circuit configured to convert power supplied from an external power source and charge a low voltage battery and a high voltage battery;
a converter control circuit configured to control the converter circuit; and
a power source circuit configured to receive supply of power from the power source or the high voltage battery and supply the power to the converter control circuit.

2. The charge control device according to claim 1, wherein
the power source is an AC power source, and
the converter circuit is an AC-DC converter.

3. The charge control device according to claim 1, wherein
in a case where power is supplied from the power source, the power source circuit receives the supply of power from the power source and supplies power to the converter control circuit, and in a case where the power is not supplied from the power source, the power source circuit receives the supply of power from the high voltage battery and supplies power to the converter control circuit.

4. The charge control device according to claim 1, further comprising:
a charge control unit configured to receive supply of power from the low voltage battery and start the supply of power from the power source.
